(19) United States
(12) Patent Application Publication
(10) Pub. No.: US 2017/0055304 A1
(43) Pub. Date: Feb. 23, 2017

(54) CONNECTION ESTABLISHMENT IN A WIRELESS BACKHAUL NETWORK

(71) Applicant: TELEFONAKTIEBOLAGET LM ERICSSON (PUBL), Stockholm (SE)

(72) Inventors: Ioanna Pappa, Stockholm (SE); Pontus Wallentin, Linköping (SE); Martin Hessler, Linköping (SE)

(21) Appl. No.: 15/306,645

(22) PCT Filed: Apr. 28, 2014
(86) PCT No.: PCT/EP2014/058574

§ 371 Date: Oct. 25, 2016

(51) Int. Cl. H04W 76/02

(52) U.S. Cl. CPC H04W 76/022; H04W 80/04

(57) ABSTRACT

There is provided means for connecting a client node to a hub node in a wireless backhaul network. Network related operations, administration, and maintenance (OAM) system information is acquired by the client node. A wireless connection is established by the client node to a hub node. The hub node is selected based on the acquired OAM system information. A start up procedure for connecting the client node to the hub node is thereby provided.

### TECHNICAL FIELD

Embodiments presented herein relate to wireless backhaul, and particularly to a method, a client node, a computer program, and a computer program product for connecting a client node to a hub node in a wireless backhaul network.

### BACKGROUND

In communications networks, it may be challenging to obtain good performance and capacity for a given communications protocol, its parameters and the physical environment in which the communications network is deployed.

For example, increase in traffic within communications networks such as mobile broadband systems and an equally continuous increase in terms of the data rates requested by end-users accessing services provided by the communications networks may impact how cellular communications networks are deployed. One way of addressing this increase is to deploy lower-power network nodes, such as micro network nodes or pico network nodes, within the coverage area of a macro cell served by a macro network node. Examples where such additional network nodes may be deployed are scenarios where end-users are highly clustered. Examples where end-users may be highly clustered include, but are not limited to, around a square, in a shopping mall, or along a road in a rural area. Such a deployment of additional network nodes is referred to as a heterogeneous or multi-layered network deployment, where the underlying layer of low-power micro or pico network nodes does not need to provide full-area coverage. Rather, low-power network nodes may be deployed to increase capacity and achievable data rates where needed. Outside of the micro- or pico-layer coverage, end-users would access the communications network by means of the overlaid macro cell.

Backhauling based on the Long Term Evolution (LTE) telecommunications standards may be carried either over normal IMT-bands, e.g. the 2.6 GHz frequency band, or by running LTE baseband communications on higher radio frequencies, such as in the 28 GHz frequency band. LTE based backhauling implies that the pico network nodes are connected to a client node which is used to create a wireless link to a hub node.

In any of the above two cases, the wireless links are typically managed by LTE core control mechanisms. For example, the LTE Mobility Management Entity (MME) may be utilized for session control of the LTE links, and the Home Subscription Service (HSS) may be utilized for storing security and Quality of Service (QoS) characteristics of the wireless links of individual wireless end-user terminals embedded in the pico network node.

Moreover, in practice more than one client node may connect to a common hub node. This implies support for Radio Resource Management (RRM) functions, such as scheduling and prioritization of the traffic to and from the different clients, at the hub node.

To each client node there might be several pico network nodes, each of which may offer one or several different radio access technologies, such as based on the Universal Mobile Telecommunications System (UMTS), LTE, or IEEE 802.11x to the wireless end-user terminals of the end-users. Therefore there is a need to differentiate between the corresponding backhaul traffic to different nodes in the communications network. For example, any LTE compliant traffic may need to end up in nodes such as the serving gateway (SGW) or the MME and any WiFi compliant traffic may end up in an edge router or an Evolved Packet Data Gateway (ePDG).

Moreover, for a given radio access technology (RAT), QoS differentiation is provided to the end-users (i.e., to the wireless end-user terminals of the end-users) so that e.g. guaranteed bitrate (GBR) services, such as voice calls, will not be disturbed by best effort (BE) services, such as web browsing. In order to enable this, QoS differentiation is needed also on the backhaul links.

If the wireless backhaul is based on LTE, there are tools that provide both the routing functions and QoS differentiation, such as based on the LTE bearer concept. Typically then, for each type of RAT, one GBR and one BE bearer are established on the backhaul links. Different frameworks may be used to prioritize between different traffic, for example to determine if 10 kbit/s Voice over Internet protocol (VoIP) data to/from one wireless end-user terminal is more or less prioritized than 10 Mbit/s web-surfing data to/from another wireless end-user terminal. The aggregated VoIP traffic for one RAT may be in the order of 10 Mbit/s. The aggregated web-surfing data traffic for one RAT may be in the order of 100 Mbit/s.

Additionally, some kind of alignment procedure should be performed in order to associate client nodes with hub nodes (and hence to associate pico network nodes with macro network nodes). Currently the procedure is performed more or less manually. This may not be suitable for pico network nodes where a fast and as possible automated procedure may be desired. It may not be obvious which particular hub node to associate a particular client node with, particularly when there is no line of sight between the particular client node and the hub nodes. Measurements may be needed, but to perform these manually could be time-consuming, involving antenna realignments between each measurement. Additionally, the client node may need a lot of information in order to automatically align the antenna (of the pico network node) and thus be able to establish a connection to a hub node. Such information can be provided locally, but again, this may require manual intervention. How the pico network node should establish a connection to the backhaul network is thus not well defined.

Hence, there is still a need for improved mechanisms for connecting a client node to a hub node in a wireless backhaul network.

### SUMMARY

An object of embodiments herein is to provide efficient mechanisms for connecting a client node to a hub node in a wireless backhaul network.

The inventors of the enclosed embodiments have thus realized that in order to configure the client nodes remotely (e.g., from a central OAM system) with this information to setup the connection, it would need a connection to the central OAM system. The inventors of the enclosed embodiments have further realized that there is currently no specified procedure as to how the client node will acquire connectivity to the network in order to access information of the central OAM system.

A particular object is therefore to provide efficient mechanisms for connecting a client node to a hub node in a wireless backhaul network enabling efficient access to OAM information.

According to a first aspect there is presented a method for connecting a client node to a hub node in a wireless backhaul network. The method is performed by the client node. The method comprises acquiring network related operations, administration, and maintenance (OAM) system information. The method comprises establishing a wireless connection to a hub node, wherein the hub node is selected based on the acquired OAM system information.

Advantageously this provides an efficient mechanism for connecting a client node to a hub node in a wireless backhaul network.

Advantageously this provides an efficient mechanism for connecting a client node to a hub node in a wireless backhaul network with efficient access to OAM information.

Advantageously this provides a plug-and-play installation for the client node.

Advantageously, the method may be based on existing auto provisioning flow as used by pico radio base stations, implying simplified combined installation of the client node and a pico radio base station.

Advantageously this provides a mechanism to find the best hub node and to subsequently perform antenna alignment.

Advantageously this provides a simple procedure to offer connectivity to the OAM system in a fast and reliable way, for example using any IP connection.

Advantageously this provides a streamlined procedure to configure the client for OAM and self optimizing network operations.

According to a second aspect there is presented a client node for connecting the client node to a hub node in a wireless backhaul network. The client node comprises a processing unit. The client node is configured to acquire network related operations, administration, and maintenance (OAM) system information. The client node is configured to establish a wireless connection to a hub node, wherein the hub node is selected based on the acquired OAM system information.

According to a third aspect there is presented a computer program for connecting a client node to a hub node in a wireless backhaul network, the computer program comprising computer program code which, when run on a processing unit, causes the processing unit to perform a method according to the first aspect.

According to a fourth aspect there is presented a computer program product comprising a computer program according to the third aspect and a computer readable means on which the computer program is stored.

It is to be noted that any feature of the first, second, third and fourth aspects may be applied to any other aspect, wherever appropriate. Likewise, any advantage of the first aspect may equally apply to the second, third, and/or fourth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1a and 1b are schematic diagrams illustrating communications networks according to embodiments;

FIG. 2a is a schematic diagram showing functional units of a client node according to an embodiment;

FIG. 2b is a schematic diagram showing functional modules of a client node according to an embodiment;

FIG. 3 shows one example of a computer program product comprising computer readable means according to an embodiment;

FIGS. 4 and 5 are flowcharts of methods according to embodiments; and

FIG. 6 schematically illustrates data and control signalling between nodes according to embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

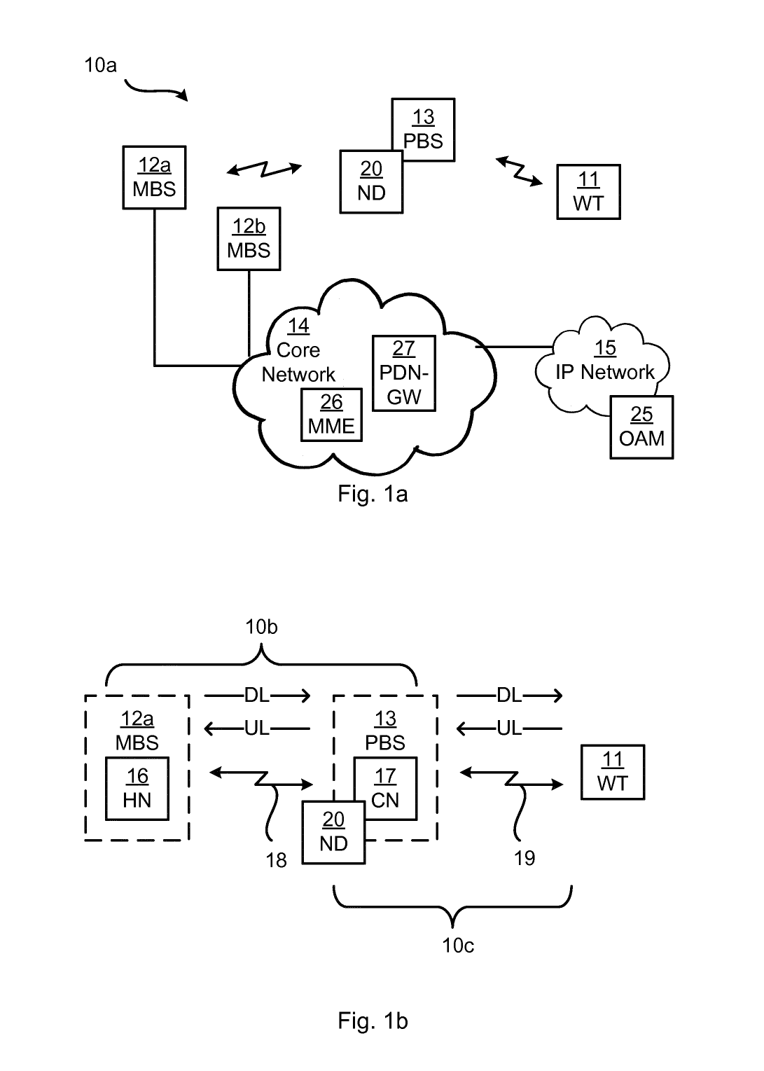

FIG. 1a is a schematic diagram illustrating a communications network 10a where embodiments presented herein can be applied. The communications network 10a comprises macro radio base stations (MBS) 12a, 12b providing wireless backhaul to pico radio base stations (PBS) 13. The macro radio base stations 12a-b are operatively connected to a core network 14 which in turn is operatively connected to a service providing Internet Protocol based network 15. A wireless end-user terminal (WT) 11 served by a pico radio base station 13 is thereby able to access services and data provided by the IP network 15. The wireless end-user terminals 11 have a wireless connection to the pico radio base stations 13. The pico radio base stations 13 and their respective links towards served wireless end-user terminals 11 define an end-user access network 10c (see, FIG. 1b). The pico radio base stations 13 may provide one or a combination of several radio access technologies over its radio access links, e.g. 3GPP LTE, 3GPP HSPA (high speed packet access), 3GPP GSM (global system for mobile communications) or IEEE 802.11x (WiFi). Each pico radio base station 13 needs to backhaul the end-user access network traffic and uses a wireless link towards a macro radio base station 12a-b for this purpose.

The pico radio base stations 13 may be backhauled by means of “client nodes” (CN) and “hub nodes” (HN). In general terms, the client node and the hub node are logical entities. The client node establishes a backhaul connection to the core network via the hub node. In case of a wireless backhaul, the term “client node” thus denotes the unit (or subunit within a micro or pico radio base station) that connects the micro or pico radio base station 13 to the hub node. The hub node denotes the other end (with respect to the client node) of the wireless backhaul link where the wireless backhaul continues over a wired or wireless connection to the core network.

The pico radio base stations 13 may thus be configured for communications not only with wireless terminals 11 but also with a macro radio base station 12a. Alternatively the pico radio base stations 13 may be configured only for communications with wireless terminals 11. In such scenarios a network device (ND) 20 may be provided for facilitating communications between the client node 17 (and hence the pico radio base stations 13) and the hub node 16 (and hence the macro radio base station 12a). The network device 20 may be implemented as general wireless transceiver device, such as a wireless terminal or a pico radio base station. In order to simplify the notation of this disclosure and without loss of generality the client node 17 will henceforth be disclosed as communicating with the hub node 16 (and hence the macro radio base station 12a) and further with entities of the core network 14 and/or entities of, or operatively connected to, the IP network 15. As such the client node 17 may be co-located with either the pico radio base stations 13 or the network device 20.

The core network 14 may for example comprise a mobility management node, such as a mobility management entity (MME) 26. In general terms, the MME may be regarded as a key control-node for the Long Term Evolution (LTE) access-network. It is responsible for idle mode wireless terminal mobility procedures including paging and tracking area update. It is involved in the bearer activation/deactivation process and is also responsible for choosing the serving gateway (SGW) for a wireless terminal 11 at the initial attach and at time of intra-LTE handover involving Core Network (CN) node relocation.

The core network 14 may for example comprise a packet data network gateway (PDN-GW) 27. The PDN-GW 27 provides connectivity from the wireless terminal 17 to external packet data networks 15 by being the point of exit and entry of traffic for the wireless terminal 11. A wireless terminal 11 may have simultaneous connectivity with more than one PDN-GW 27 for accessing multiple PDN-GWs. The PDN-GW 27 performs policy enforcement, packet filtering for each user, charging support, lawful interception and packet screening. Another role of the PDN-GW 27 is to act as an anchor for mobility between 3GPP and non-3GPP technologies such as WiMAX and 3GPP2 (CDMA 1X and EvDO).

The IP network 15 comprises, or is operatively connected to, a server 25 hosting operations, administration, and maintenance (OAM, or OA&M) system information. As the skilled person understands, there may be more than one IP network 15, each of which being accessed via separate PDN-GW:s. For example, the OAM system may reside in a separate IP network or reside in the public Internet. For simplicity of notation only one IP network 15 is illustrated in FIG. 1a. In general terms, operations, administration and management or operations, administration and maintenance (OA&M or OAM) is the processes, activities, tools, standards etc. involved with operating, administering, managing and maintaining any system. This commonly applies to computer networks or computer hardware.

FIG. 1b is a schematic diagram illustrating a communications network where embodiments presented herein can be applied. The communications network of FIG. 1b comprises a macro radio base station (MBS) 12a and a pico radio base station (PBS) 13. FIG. 1b further schematically illustrates a wireless backhaul network 10b and an end-user access network 10c. In the end-user access network 10c a wireless end-user terminal (WT) 11 is served by the pico radio base station 13 over a wireless link 19. In FIG. 1b also downlink (DL) and uplink (UL) directions are indicated. In the wireless backhaul network 10b the macro radio base station 12a provides wireless backhaul over a wireless link 18 to the pico radio base station 13. As illustrated in FIG. 1b, a hub node 16 may be co-located with a macro radio base station 12a and a client node 17 may be co-located with a pico radio base station 13. Hence, the hub node 16 may be implemented in a macro radio base station 12a, and the client node 17 may be implemented in a micro radio base station or a pico radio base station 13. However, the pico radio base station 13 and the client node 17 do not need to be co-located. The same applies for the hub node 16 and the macro radio base station 12a which thus may or my not be co-located.

The embodiments disclosed herein relate to connecting a client node 17 to a hub node 16 in a wireless backhaul network 10b. This may enable the client node 17 to, for example, over the wireless backhaul network 10b, be auto-configured and/or auto-integrated into the wireless backhaul network 10b. In order to obtain such connectivity there is provided a client node 17, a method performed by the client node 17, a computer program comprising code, for example in the form of a computer program product, that when run on a processing unit, causes the processing unit to perform the method.

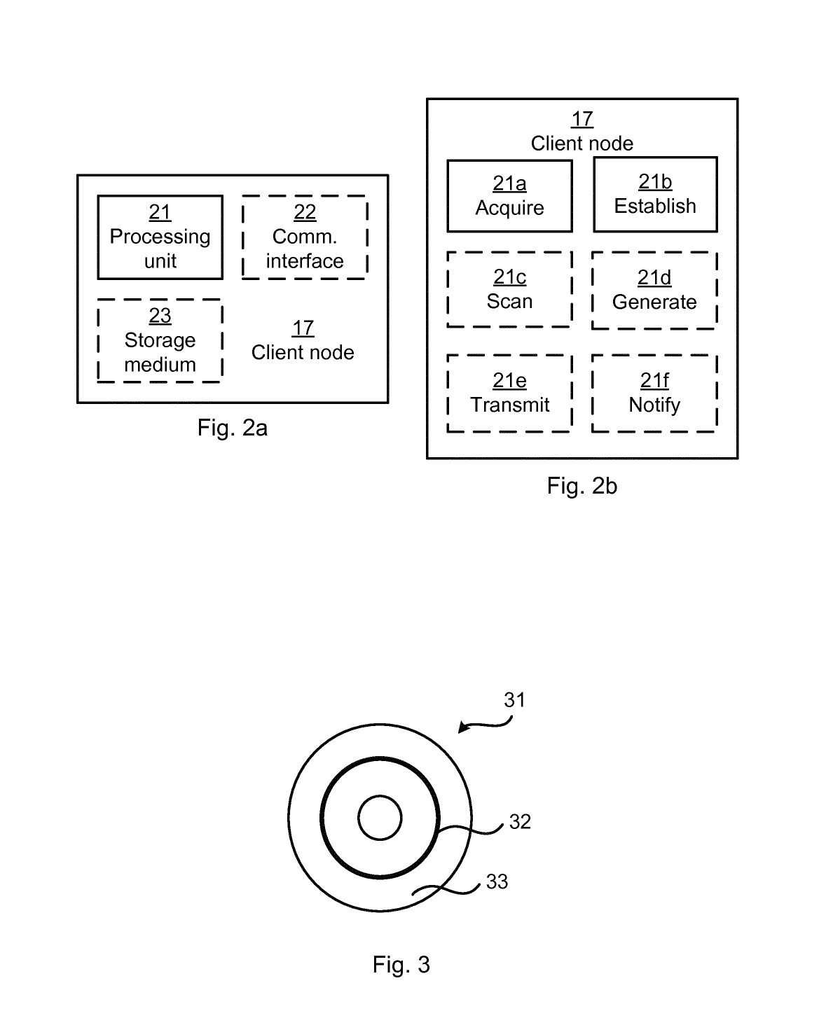

FIG. 2a schematically illustrates, in terms of a number of functional units, the components of a client node 17 according to an embodiment. A processing unit 21 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 31(as in FIG. 3), e.g. in the form of a storage medium 23. Thus the processing unit 21 is thereby arranged to execute methods as herein disclosed. The storage medium 23 may also comprise persistent storage, which, for example, can be any single one or combination of magnetic memory, optical memory, solid state memory or even remotely mounted memory. The client node 17 may further comprise a communications interface 22 for communications with any of at least one hub node 16 and, at least one other client node 17, at least one macro base station 12a, at least one pico base station 13, and at least one network device 20. As such the communications interface 22 may comprise one or more transmitters and receivers, comprising analogue and digital components and a suitable number of antennas for radio communications and/or interfaces for wired communications. The processing unit 21 controls the general operation of the network device 20 e.g. by sending data and control signals to the communications interface 22 and the storage medium 23, by receiving data and reports from the communications interface 22, and by retrieving data and instructions from the storage medium 23. Other components, as well as the related functionality, of the client node 17 are omitted in order not to obscure the concepts presented herein.

FIG. 2b schematically illustrates, in terms of a number of functional modules, the components of a client node 17 according to an embodiment. The client node 17 of FIG. 2b comprises a number of functional modules; an acquire module 21a, and an establish module 21b. The client node 17 of FIG. 2b may further comprise a number of optional functional units, such as a scan module 21c, a generate module 21d, a transmit module 21e, and a notify module 21f. The functionality of each functional module 21a-f will be further disclosed below in the context of which the functional units may be used. In general terms, each functional module 21a-f may be implemented in hardware or in software. The processing unit 21 may thus be arranged to from the storage medium 23 fetch instructions as provided by a functional module 21a-f and to execute these instructions, thereby performing any steps as will be disclosed hereinafter.

The client node 17 may be provided as a standalone device or as a part of a further device. For example, the client node 17 may be provided as part of a network device 20 or a pico radio base station 13. The client node 17 may be co-located with a radio resource management (RRM) functionality. The client node 17 may be provided as an integral part of the network device 20 or the pico radio base station 13. That is, the components of the client node 17 may be integrated with other components of the network device 20 or the pico radio base station 13; some components of the network device 20 or the pico radio base station 13 and the client node 17 may be shared. For example, if the network device 20 or the pico radio base station 13 as such comprises a processing unit, this processing unit may be arranged to perform the actions of the processing unit 21 of the client node 17. Alternatively the client node 17 may be provided as a separate unit in the network device 20 or the pico radio base station 13.

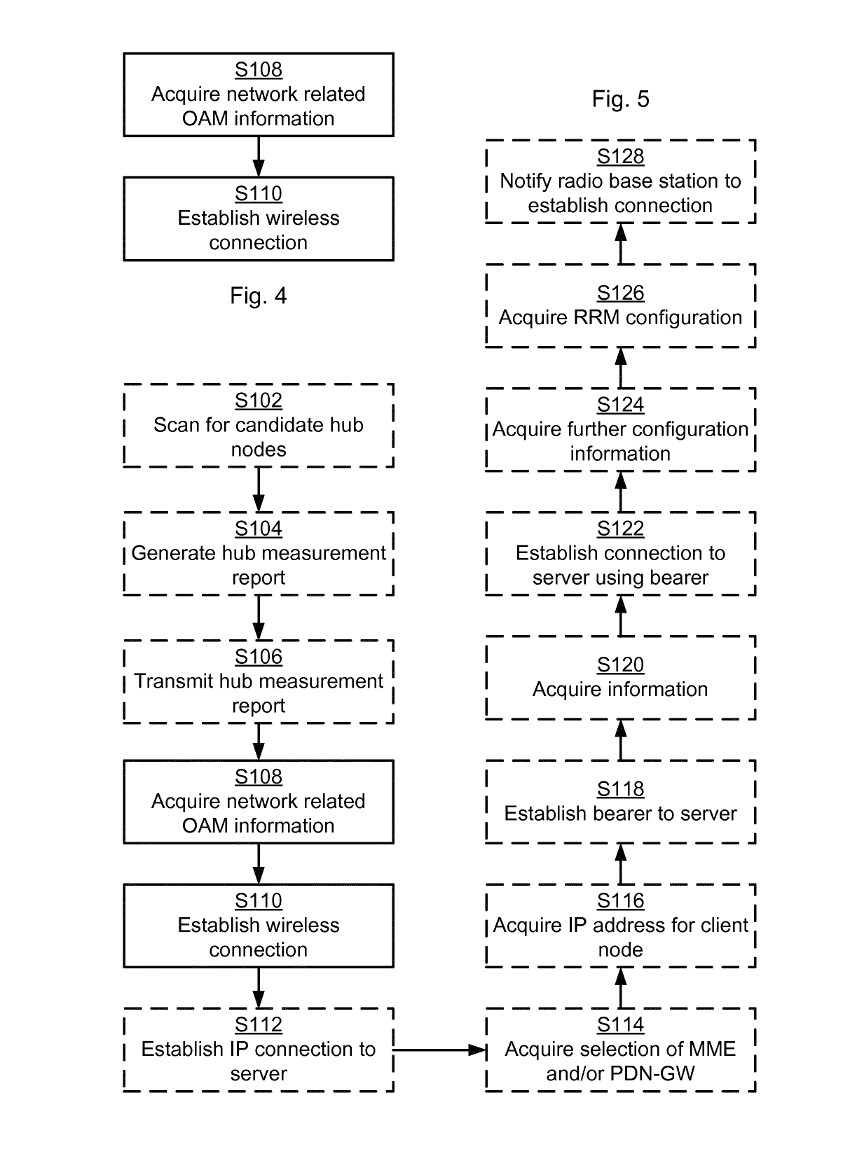

FIGS. 4 and 5 are flow chart illustrating embodiments of methods for connecting a client node 17 to a hub node 16 in a wireless backhaul network 10b. The methods are performed by the client node 17 and/or the network device 20. The methods are advantageously provided as computer programs 32. FIG. 3 shows one example of a computer program product 31 comprising computer readable means 33. On this computer readable means 33, a computer program 32 can be stored, which computer program 32 can cause the processing unit 21 and thereto operatively coupled entities and devices, such as the communications interface 22 and the storage medium 23 to execute methods according to embodiments described herein. The computer program 32 and/or computer program product 31 may thus provide means for performing any steps as herein disclosed.

In the example of FIG. 3, the computer program product 3 1 is illustrated as an optical disc, such as a CD (compact disc) or a DVD (digital versatile disc) or a Blu-Ray disc. The computer program product 31 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory. Thus, while the computer program 32 is here schematically shown as a track on the depicted optical disk, the computer program 32 can be stored in any way which is suitable for the computer program product 31.

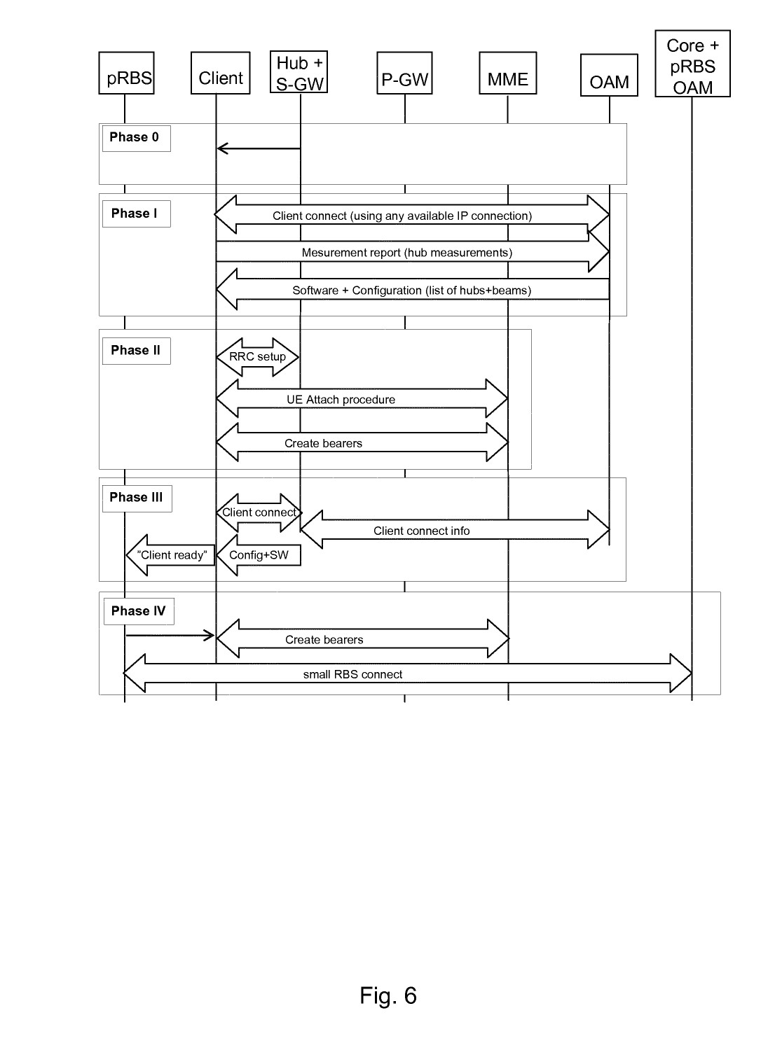

Reference is now made to FIG. 4 illustrating a method for connecting a client node 17 to a hub node 16 in a wireless backhaul network 10b according to an embodiment. The method is performed by the client node 17. Parallel reference is made to the signalling diagram of FIG. 6.

The method is based on operations, administration, and maintenance (OAM) system information being acquired by the client node 17. Particularly, the client node 17 is configured to, in a step S108, acquire network related OAM system information. This OAM system information is used by the client node 17 to establish a wireless connection to a hub node 16. The client node 17 is thus configured to, in a step S110, establish a wireless connection to the hub node 16. The hub node is selected based on the acquired OAM system information. The client node 17 may be regarded as a logical node. The step S110 of establishing may thus be interpreted as the client node 17 being configured to instruct a physical node, such as the network device 20, operatively connected to the client node 17 to establish the wireless connection to the hub node 16 on behalf of the client node 17. This may enable smooth auto-integration in terms of identification and establishment of suitable hub connections at client start-up.

Embodiments relating to further details of connecting a client node 17 to a hub node 16 in a wireless backhaul network 10b will now be disclosed.

Reference is made to FIG. 5 illustrating methods for connecting a client node 17 to a hub node 16 in a wireless backhaul network 10b according to further embodiments. Parallel reference is continued to the signalling diagram of FIG. 6.

The procedure proposed may be regarded as comprising a number of phases, hereinafter referred to as Phase 0, Phase I, Phase II, Phase III, and Phase IV. Embodiments relating thereto will now be disclosed in turn. However, as is understood by the skilled person, some of the steps/feature disclosed with reference to a particular phase may alternatively be performed during, or be part or, another phase, mutatis mutandis.

Phase 0: The client node 17 may scan for candidate hub nodes, for example in order to create a hub measurement report. According to an embodiment the client node 17 is thus configured to, in an optional step S102, scan for candidate hub nodes.

The client node 17 may thus perform a scan of hub nodes 16, for example using antenna mechanical steering or other means to direct the antenna reception. The measurements may then be processed and then some (e.g., the strongest) or all measurement results are included in a hub measurement report. According to an embodiment the client node 17 is thus configured to, in an optional step S104, generate a hub measurement report based on the scanning. Steps S102 and S104, are, if executed, performed prior to the above disclosed step S108. The OAM system information may thus be based on the hub measurement report. The hub measurement report may further comprise at least one of measurement data, configuration data, and location data of the client node 17. The location data may be generated in the client node 17 by the client node 17 accessing existing location services, e.g., a Global Positioning System (GPS) service or a cellular location service. The location data may be signaled using the identity of the client node 17 as, for example, being available in the OAM system (e.g., having been entered into the OAM system when deploying the client node 17).

The OAM system may use the location information and/or the hub-measurement report to provide an initial configuration to the client node 17. Alternatively the client node 17 may itself use the location information and/or the hub-measurement report to acquire initial configuration. The client node 17 may acquire the initial configuration remotely (e.g., over an at least partly wireless medium) or locally (e.g., over a direct interface to OAM information) according to the examples provided in Phase I below.

The hub measurement report may be transmitted to the OAM system. According to an embodiment the client node 17 is thus configured to, in an optional step S106, transmit the hub measurement report to a server 25 hosting the OAM system information.

The hub measurement report may be transmitted over the connection established in step S112, see below. The hub measurement report may be used to trigger, for example synchronization signal based measurement procedures, such as primary and/or secondary synchronization signal (PSS/SSS) based measurement procedures to identify the best hub node 16 and/or sector of the hub node 16 for the client node 17 to connect to.

Phase I: Step S108 may be regarded as being part of Phase I. Further details of Phase I will now be disclosed. The OAM system information may comprise configuration information (such as new client software and/or site specific configuration) for the client node 17. There may be different ways for the client node 17 to acquire the network related OAM system information. Different embodiments relating thereto will now be described in turn.

For example, acquiring the network related OAM system information may involve establish any kind of IP connection, which for example could occur over e.g., a cellular or a WiFi network (and hence over, for example, the wireless backhaul network 10b or the wireless end-user access network 10c). According to an embodiment the acquiring in step S108 thus involves the client node 17 to be configured to, in an optional step S112, establish an Internet Protocol (IP) based connection to a server 25 hosting the OAM system information. There may thus be a wireless or a wired connection to the OAM system. Hence, the IP based connection may at least partly be over a wireless transmission medium. The OAM system may thereby be made aware of the initiation of the (new) client node 17 and prepare Phase II (see below).

Alternatively the OAM system information is acquired from a removable memory media, such as from a universal serial bus (USB) flash drive. This may require an operator or a technician to physically insert the USB flash drive into a USB flash drive reading interface of (or operatively connected to) the client node 17. According to some embodiments the access to the OAM system information is thus provided by an external device being operatively connected to the client node, for example, provided by the operator or technician performing an installation process.

Phase II: Step S110 may be regarded as being part of Phase II. Further details of Phase II will now be disclosed. In general terms, in Phase II the client node 17 may initiate an antenna alignment procedure and may as a wireless terminal connect to a selected hub node 16 and mobility management node, such as a mobility management entity (MME) 26 and/or packet data network gateway (PDN-GW) 27. Hence, according to an embodiment the client node 17 is configured to, in an optional step S114, acquire a selection of at least one of an MME 26 and a PDN-GW 27 for a wireless connection between the client node 17 and the hub node 16.

In Phase II the assignment of primary IP address to the client node 17 may be performed. According to an embodiment the client node 17 is therefore configured to, in an optional step S116, acquire an Internet Protocol (IP) address for the client node 17. In Phase II the establishment of backhaul EPS bearer to the OAM system may be completed. According to an embodiment the client node 17 is therefore configured to, in an optional step S118, establish a bearer to a server 25 hosting the OAM system information via the wireless connection established in step S114.

Phase II may involve optional other measurements to be acquired. According to an embodiment the client node 17 is thus configured to, in an optional step S120, acquire information relating to at least one of hub node signal strength, hub node signal quality measurements, time-of-day information, date information, user input, a random number, pico radio base station (PBS) information from a PBS 13 associated with the client node 17, and measurement data from the RBS 13. In Phase II one hub-client connection is available and no further manual intervention is needed. Hence the optional information may take more time for the client node 17 to acquire without adversely affecting the installation time of the client node 17.

Phase III: In general terms, Phase III may involve the client node 17 to again connect to the OAM system, but this time via the connection established in Phase II. According to an embodiment the client node 17 is thus configured to, in an optional step S122, establish a connection to the server 25 hosting the OAM system information using the bearer established in step S118.

The client node 17 may then receive additional configuration information and software. According to an embodiment the client node 17 is therefore configured to, in an optional step S124, acquire further configuration information from the server 25 via the wireless connection established in step S114 (and using the bearer established in step S118).

The client node 17 may inform the server 25 hosting the OAM system about the start-up procedure. The client node 17 may be configured for self-organizing network (SON) operations. SON has been codified within 3GPP Release 8 and subsequent specifications in a series of standards, including 3GPP TR 36.902, and is thus as such known by the person skilled in the art. According to an embodiment the client node 17 is configured to, in an optional step S126, acquire radio resource management (RRM) configuration for the wireless connection established in step S114 (and using the bearer established in step S118). The client node 17 may thereby be ready to serve traffic for the PBS 13.

Phase IV: In general terms, Phase IV may involve the client node 17 to notify PBS 13 to establish connection to the OAM system and the core network. Hence, according to an embodiment the client node 17 is configured to, in an optional step S128, notify a radio base station 13 to establish a connection to a server hosting OAM system information. The PBS 13 may then try to connect to a server hosting the OAM system and the core network. In some cases the PBS 13 may use the backhaul connection provided by the client to send traffic e.g., to the core network or a router. The PBS 13 may connect to an OAM server which is different from the server 25 the client node 17 connects to. This triggers the establishment of additional backhaul evolved packet system (EPS) bearers to carry the traffic of the PBS 13. Proprietary backhaul features may be enabled through OAM proxy software.

In summary, according to the herein disclosed embodiments there has been presented a start up procedure for connecting a client node 17 to a hub node 16 in a wireless backhaul network 10b that enables the client to connect to the wireless backhaul network 10b. The procedure comprises phases that abide by the 3GPP standards.

As disclosed above, in the client startup procedure in Phase I, the client node 17 may have a generic software and configuration and may connect to the OAM system using any available IP connection.

The client node 17 may make a scan of hub nodes 16 using antenna mechanical steering or other means to direct the antenna reception. The measurements may be processed and then some (e.g. the strongest) or all measurement results may be included in a hub-measurement report which may be sent to the OAM system, for example over the already established any available IP connection. This report may be used to trigger, for example, SSS/PSS-based measurement procedures to identify the best hub node 16 and/or hub sector for the client node 17 to connect to. As disclosed above, this may occur in Phase I for measurements in a manual installation phase or in Phase II for measurement procedures controlled by OAM SON functionalities. Phase II measurement may be triggered at any time from the OAM system when some connection is established and available, for example, to some default hub sector or through any other IP connection.

In messages to the OAM system, the client node 17 may provide its location and/or the hub measurement message. According to some embodiments the location is generated in the client via existing location services, e.g. GPS or a cellular location service. According to some embodiments, the location is signaled using the client identity available in the OAM system, for example entered into the OAM system, when deploying the client node 17. The OAM system may then use the location information and hub-measurement report to provide an initial configuration to the client node 17. This initial configuration is typically location-dependent, and in particular it may include information to the client node 17 that is used to find and connect to the correct hub node 17.

Some of the embodiments described above may be summarized in the following manner:

One embodiment is directed to a method for connecting a client node to a hub node in a wireless backhaul network. The method is performed by the client node and comprises the steps of:
acquiring network related operations, administration, and maintenance, (OAM) system information; and
establishing a wireless connection to a hub node, wherein the hub node is selected based on the acquired OAM system information.

The method may further comprise, prior to said acquiring:
scanning for candidate hub nodes; and
generating a hub measurement report based on said scanning; and
wherein the OAM system information is based on the hub measurement report.

The method may further comprise:
transmitting said hub measurement report to a server (25) hosting the OAM system information.

The hub measurement report may further comprise at least one of measurement data, configuration data, and location data of the client node.

The OAM system information may comprise configuration information for the client node.

The method may further comprise:
establishing an Internet Protocol (IP) based connection to a server hosting the OAM system information.

The IP based connection may at least partly be over a wireless transmission medium.

The OAM system information may be acquired from a removable memory media.

The method may further comprise:
acquiring a selection of at least one of a mobility management entity, (MME) and a packet data network gateway (PDN-GW) for a wireless connection between the client node and the hub node.

The method may further comprise:
acquiring an Internet Protocol (IP) address for the client node.

The method may further comprise:
establishing a bearer to a server hosting the OAM system information via the wireless connection.

The method may further comprise:
acquiring information relating to at least one of hub node signal strength, hub node signal quality measurements, time-of-day information, date information, user input, a random number, pico radio base station (PBS) information from a PBS associated with the client node, measurement data from said RBS.

The method may further comprise:
establishing a connection to the server hosting the OAM system information using said bearer.

The method may further comprise:
acquiring further configuration information from said server via said wireless connection.

The method may further comprise:
acquiring radio resource management (RRM) configuration for said wireless connection.

The method may further comprise:
notifying a radio base station to establish a connection to a server hosting the OAM system information.

One embodiment is directed to a client node configured to perform any such methods.

One embodiment is directed to a computer program comprising computer code which, when run on a processing unit, causes the processing unit to perform any such methods.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for connecting a client node to a hub node in a wireless backhaul network, the method being performed by the client node and comprising the steps of:
acquiring network related operations, administration, and maintenance, OAM, system information; and
establishing a wireless connection to a hub node, wherein the hub node is selected based on the acquired OAM system information.

2. The method according to claim 1, further comprising, prior to said acquiring:
scanning for candidate hub nodes; and
generating a hub measurement report based on said scanning; and
wherein the OAM system information is based on the hub measurement report.

3. The method according to claim 2, further comprising:
transmitting said hub measurement report to a server hosting the OAM system information wherein said hub measurement report further comprises at least one of measurement data, configuration data, and location data of the client node.

4-5. (canceled)

6. The method according to claim 1, wherein said acquiring further comprises:
establishing an Internet Protocol, IP, based connection to a server hosting the OAM system information wherein said IP based connection at least partly is over a wireless transmission medium.

7. (canceled)

8. The method according to claim 1, wherein the OAM system information is acquired from a removable memory media.

9. The method according to claim 1, further comprising:
acquiring a selection of at least one of a mobility management entity, MME, and a packet data network gateway, PDN-GW, for a wireless connection between the client node and the hub node.

10. (canceled)

11. The method according to claim 9, further comprising:
establishing a bearer to a server hosting the OAM system information via the wireless connection.

12. The method according to claim 1, further comprising:
acquiring information relating to at least one of hub node signal strength, hub node signal quality measurements, time-of-day information, date information, user input, a random number, pico radio base station, PBS, information from a PBS associated with the client node, measurement data from said RBS.

13. The method according to claim 11, further comprising:
establishing a connection to the server hosting the OAM system information using said bearer.

14. The method according to claim 13, further comprising:
acquiring further configuration information from said server via said wireless connection.

15. (canceled)

16. The method according to claim 1, further comprising:
notifying a radio base station to establish a connection to a server hosting the OAM system information.

17. A client node for connecting the client node to a hub node in a wireless backhaul network, the client node comprising a processing unit configured to:
acquire network related operations, administration, and maintenance, OAM, system information; and
establish a wireless connection to a hub node, wherein the hub node is selected based on the acquired OAM system information.

18. The client node according to claim 17, wherein the processing unit is configured to, prior to acquire network related OAM system information:
scan for candidate hub nodes; and
generate i a hub measurement report based on said scanning; and
wherein the OAM system information is based on the hub measurement report.

19. The client node according to claim 18, wherein the processing unit is configured to:
transmit said hub measurement report to a server hosting the OAM system information wherein said hub measurement report further comprises at least one of measurement data, configuration data, and location data of the client node.

20-21. (canceled)

22. The client node according to claim 17, wherein the processing unit is configured to:
establish an Internet Protocol, IP, based connection to a server hosting the OAM system information wherein said IP based connection at least partly is over a wireless transmission medium.

23. (canceled)

24. The client node according to claim 17, wherein the OAM system information is acquired from a removable memory media.

25. The client node according to claim 17, wherein the processing unit is configured to:
acquire a selection of at least one of a mobility management entity, MME, (26) and a packet data network gateway, PDN-GW, for a wireless connection between the client node and the hub node.

26. (canceled)

27. The client node according to claim 26, wherein the processing unit is configured to:
establish a bearer to a server hosting the OAM system information via the wireless connection.

28. The client node according to any claim 17, wherein the processing unit is configured to:
acquire information relating to at least one of hub node signal strength, hub node signal quality measurements, time-of-day information, date information, user input, a random number, pico radio base station, PBS, information from a PBS associated with the client node, measurement data from said RBS.

29. The client node according to claim 27, wherein the processing unit is configured to:
establish a connection to the server hosting the OAM system information using said bearer.

30. The client node according to claim 29, wherein the processing unit is configured to:
acquire further configuration information from said server via said wireless connection.

31. (canceled)

32. The client node according to any claim 17, wherein the processing unit is configured to:
notify a radio base station to establish a connection to a server hosting the OAM system information.

33.-34. (canceled)
